(19) United States
(12) Patent Application Publication
(10) Pub. No.: US 2005/0044107 A1
(43) Pub. Date: Feb. 24, 2005

(54) Auto generation of build of material data

(76) Inventor: Steven W. Widner, Vermillion, SD (US)

Correspondence Address: SUITER- WEST PC LLC, 14301, FNB PARKWAY SUITE 320, OMAHA, NE, 68154, US

(21) Appl. No.: 10/646,164

(22) Filed: Aug. 22, 2003

(51) Int. Cl. G06F 11/00

(52) U.S. Cl. 707/104.1; 714/25

(57) ABSTRACT

A system and method for generating and providing file markers encoded with build of material information. The build of material information is identified from a source file and the file marker is encoded with the build of material information. The encoded file marker may be sent to a central authority upon the abnormal termination of an application in the computer system.

### FIELD OF THE INVENTION

The present invention generally relates to the field of computer systems, and particularly to a system and method for generating and providing build of material data, such as for use during a software failure or the like.

### BACKGROUND OF THE INVENTION

Computers are an integral part of everyday life. From personal computers used in the homes and businesses around the world, to supercomputers, to networked computing environments, these information handling systems pervade every aspect of modern life. There are many different manufacturers and retailers of computers and computer parts. Often times the creation of the many various computers from a diverse array of computer parts is problematic. Users of computers may experience these problems as computer system failures, such that one part of a computer is not able to talk to another part, and therefore execution of an application desired by the user is not possible.

There are many ways in which users of computers, in all types of environments, handle computer failures. From the personal computer user to the network administrator, perhaps one of the most familiar and popular methods of dealing with failures is to contact a central authority, such as a call center provided by a computer manufacturer, software retailer, or computer retailer, to discuss and solve the problem. This method has proven to be effective, but is significantly hampered by requirements for manual generation of the necessary information to be provided in order to solve problems.

Currently, file markers are used as a way of gathering failure data from computer systems experiencing a system failure or “crash.” The file markers may identify the source of the failure (e.g., device driver, software application, operating system) by specifying a version of the software component currently being employed upon the computer system. Unfortunately, the data contained in a file marker is still manually generated ed by computer manufacturers, software retailers, computer retailers, and the like, for solving problems.

Therefore, it would be desirable to provide a system and method for generating file markers encoded with build of material information without requiring manual input and providing the generated file markers to a central authority when needed.

### SUMMARY OF THE INVENTION

Accordingly, the present invention provides a build of material (BOM) information generation system and method that provides the needed BOM information regarding a source file of a computer system experiencing a failure in order to effectively address the problem. Customers of computer systems may contact the computer and/or software provider when they experience a failure in the operation of their computer. For example, Gateway™ presently tracks technical support calls based on data entry collected on the phones during actual customer support calls. Additional methods may include gathering data on failures from customers who chose to send error reports when their computer system crashes. It is an object of the present invention to provide for the generation and providing of build of material (BOM) data for use in failure analysis of customer failures, on a system restoration CD, and for future use in identifying and diagnosing technical support issues, while avoiding manual generation of this failure data.

In a first aspect of the present invention, a method for generating build of material information in a computer system comprises identifying build of material information in a source file of the computer system. After the BOM information is identified, a file marker is encoded with the BOM information and then the file marker is stored in a physical storage location. This method provides for the automatic generation of BOM information which is a significant advantage over the manual methods employed previously. It is an object of the present invention that this method of generating BOM information may be employed upon a computer system already containing source files to be read. Therefore, the current invention may be provided on various media which may be read by a computer system.

In a second aspect of the present invention, a method for generating build of material information in a computer system includes receiving a source file into the computer system and identifying BOM information in the source file received. A file marker is encoded with the BOM information from the source file received and then the file marker is stored in a physical storage location. This aspect contemplates the generation of a file marker including BOM information from a downloaded source file. Thus, the present invention may execute upon source files that are not resident on a computer system when the present invention is first downloaded.

In a third aspect of the present invention, a method of providing build of material information during a software failure comprises encoding a file marker with build of material information from a source file. Once encoded, the file marker is sent to a central authority, such as a telephone call center, web help center, and the like, when an application abnormally terminates. It is contemplated that the method may further include the step of storing the file marker in a physical storage location. This would allow the present invention to be resident upon a computer system until such time as it is needed, such as upon the occurrence of an abnormal termination of an application.

In a fourth aspect of the present invention, a signal tangibly embodying a computer readable medium for providing build of material information comprises a first command for identifying build of material information in a source file. The signal further comprises a second command for encoding a file marker with the build of material information. Then a third command stores the file marker in a physical storage location. It is understood that the signal may further include a fourth command for sending the file marker to a central authority when an application abnormally terminates.

In a still further aspect of the present invention, a computer system for providing build of material (BOM) information during a software failure comprises a processor coupled with a memory. A signal, executable by the processor, generates a file marker encoded with BOM information from a source file. A communication assembly, coupled to the processor, enables the computer system to send the file marker to a central authority when an application abnormally terminates. Wherein, the central authority uses the file marker provided for failure analysis, system restoration, and for future use in identifying and diagnosing technical support issues.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a first exemplary method for generating a file marker encoded with build of material information in accordance with an exemplary embodiment of the present invention;

FIG. 2 is an illustration of a second exemplary method for generating a file marker encoded with build of material information in accordance with an exemplary embodiment of the present invention;

FIG. 3 is an illustration representing various central authority configurations which may be in communication with the computer system of FIG. 5;

FIG. 4 is an illustration of an exemplary method of providing build of material information to a central authority during a software failure; and

FIG. 5 is an illustration of an exemplary computer system upon which the present invention may operate and through which the methods of the present invention may be executed in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

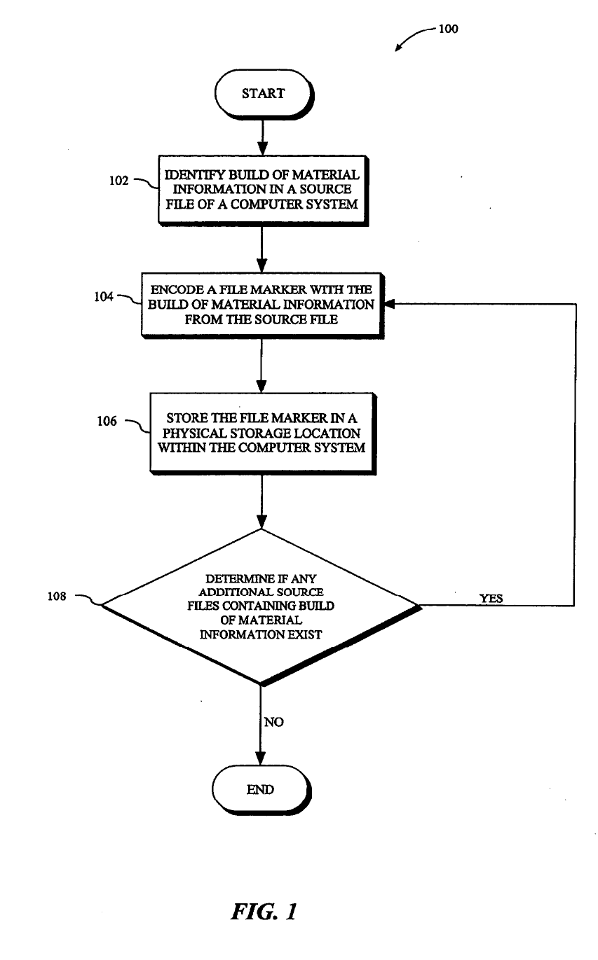

Referring generally now to FIGS. 1 through 5, exemplary embodiments of the present invention are shown.

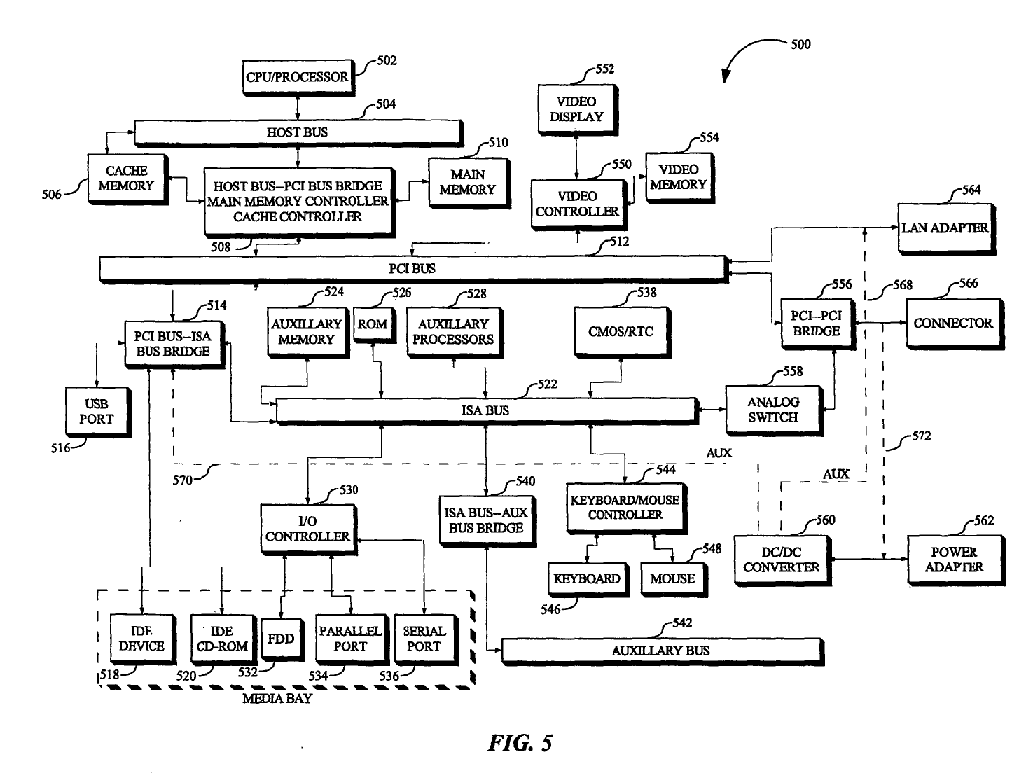

In a preferred embodiment, the present invention may be implemented as programs of instructions resident in a memory within one or more computer systems or servers configured generally as described in FIG. 5. Until required by the computer system or server, the set of instructions may be stored in another readable memory device, for example, in a hard disk drive or in a removable memory such as an optical disk for utilization in a CD-ROM drive or a DVD drive, a floppy disk for utilization in a floppy disk drive, a personal computer memory card for utilization in a personal computer card slot, or the like. Further, the program of instructions can be stored in the memory of another computer system or server and transmitted over a local area network or a wide area network, such as the Internet, an internet, an intranet, or the like, when desired by the user. Additionally, the instructions may be transmitted over a network in the form of an applet or the like that is interpreted or compiled after transmission to the computer system or server rather than prior to transmission. One skilled in the art may appreciate that the physical storage of the sets of instructions, applets, or the like physically changes the medium upon which it is stored electrically, magnetically, chemically, physically, optically, or holographically so that the medium carries computer readable information.

A flowchart 100 illustrating functional steps which may be performed by a signal tangibly embodying a computer readable medium of the present invention, is shown in FIG. 1. Preferably, the signal is embodied in a software application executable upon an information handling system. The software application may be physically located upon any computer readable medium, such as a floppy disk, CD-ROM, DVD, and the like, for storing the software application. Execution of the signal may occur on a variety of information handling systems, such as the computer system shown and described in FIG. 5. In the current method embodiment, in step 102 the signal, being executed upon a computer system, identifies build of material (BOM) information included in a source file. The source file contents, including the BOM information, may be stored in a SMBIOS (System Management Basic Input/Output System) table which is created in memory by the BIOS (Basic Input/Output System) as part of the boot process or various other locations as contemplated by one of ordinary skill in the art. It is known in the art that an SMBIOS table may also be commonly referred to as a desktop management interface (DMI) table. The signal may retrieve configuration information stored in the SMBIOS table located in memory through the SMBIOS interface. This information is then formatted for use in a file marker (described below in step 104). Build of material (BOM) information may include information identifying device drivers, software applications, operating systems, BIOS, and the like. Further, BOM information may identify any revisions made to a device and/or application, the version of the device and/or application being currently used by the computer system, and any other information as contemplated by one of ordinary skill in the art. In step 104, the signal provides for the encoding of a file marker with the BOM information identified in the source file. In the preferred embodiment of the present invention, the file marker is a null file with a file name. The fields in the file name are populated from the BOM information stored on the SMBIOS table. It is understood that the fields may be populated with BOM information stored in various sources. The file name may include any number of characters, preferably the file name includes zero to two hundred and fifty six characters. The characters may be comprised of specific, delimited fields. The fields may be product specific, such as Gateway™ product specific fields, and the delimiting may occur through a variety of methods, such as the use of underscoring and the like as may be contemplated by those of ordinary skill in the art. It is understood that various other file markers may be used, such as files storing BOM information within the file itself, files containing coded or encrypted information or file names, or the like, for storing BOM data, without departing from the scope and spirit of the present invention.

By providing for the encoding of file markers, the present invention provides a significant advantage over the prior art in that it avoids the time consuming process of manually producing information, such as that included in file markers, needed when attempting to diagnose and resolve technical support issues or during a complete system restoration. In the exemplary embodiment described above, the process of generating BOM information is automatically handled by the signal through the encoding of file markers. In step 106, the file marker is stored in a physical storage location. The physical storage location may be within the computer system, such as within the Hard Disk Drive (HDD). Alternatively, the file markers may be stored upon a variety of media, such as a floppy disk, CD-ROM, DVD, flash media device (i.e., memory stick), and the like. After the file marker is stored, step 108 determines if any additional source files containing build of material information exist. If it is determined that there are additional source files, then the method returns to step 104 and a new file marker, encoded with the new build of material information from the additional source file, is generated. The present invention provides an executable that may continue to create file markers, each encoded with a specific build of material information relating to a source file, until it identifies that no additional source files exist. It is contemplated that the number of file markers created may be limited by the signal of the present invention without departing from the scope and spirit of the present invention.

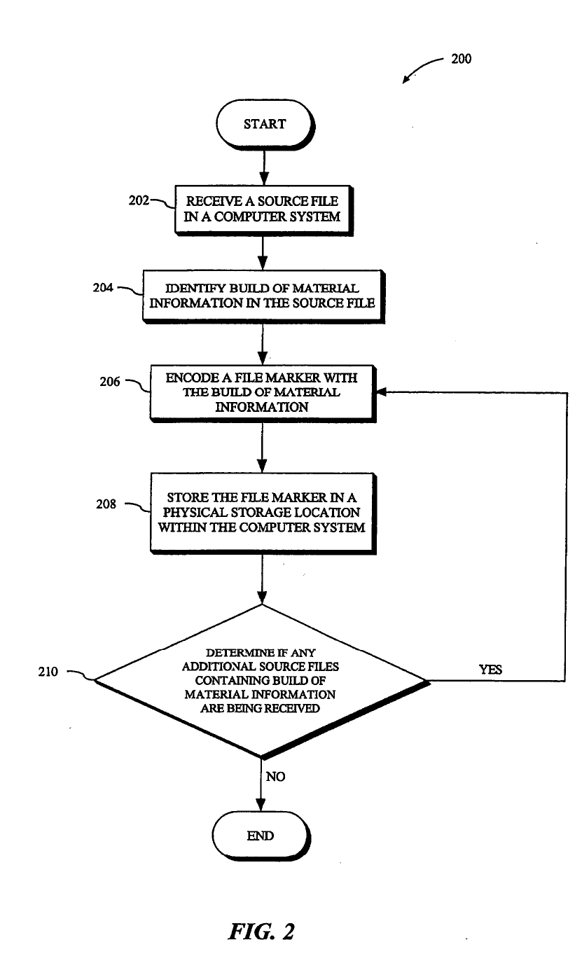

A second exemplary method 200 for generating build of material information is shown in FIG. 2. In the current embodiment, the method is performed by a signal executable upon a computer system, such as that shown and described in FIG. 5. The computer system, in step 202, receives a source file. The source file is similar to that described above in reference to FIG. 1. It is understood that the receiving of the source file by a computer system is referred to as a download by those of ordinary skill in the art. This download of information may occur through use of a variety of methods. For instance, the download may come from information contained on a diskette. Many software applications, such as computer games and operating systems are received by computer systems in this form. Other methods of downloading information may include the use of a networked computing environment. For instance, a local area network (LAN), common to business environments, may provide information to a managing computer, such as a server. All other connected computer systems may then download that information. Another example would be information downloaded over the World Wide Web, a wide area network (WAN), storage area network (SAN), and the like.

Upon receipt of the source file by the computer system, the present invention in step 204 identifies the BOM information in the source file. As discussed above, the BOM information may include various types of information associated with the source file. It is understood that the identification of the BOM information within the source file may occur at various stages of the download process. For instance, the BOM information may be identified at any point during the downloading of the source file, upon completion of the download, or after the downloaded source file has been placed into a storage location. In step 206, a file marker is encoded with the BOM information from the source file and then the file marker is stored in a physical storage location in step 208. These steps are similar to steps 104 and 106 shown and described in reference to FIG. 1 above. After storing the file marker, step 210 includes determining if any additional source files containing BOM information are being received. If it is determined that there are additional source files being received, then the method proceeds back to step 206, generating a new file marker encoded with new BOM information from the new source file received. The present invention may continue to create file markers until no additional source files are received, or provide a limiting factor specifying the total number of file markers to be created. Once it is determined that no additional source files are being received, or upon reaching the limiting number, the present invention terminates its execution.

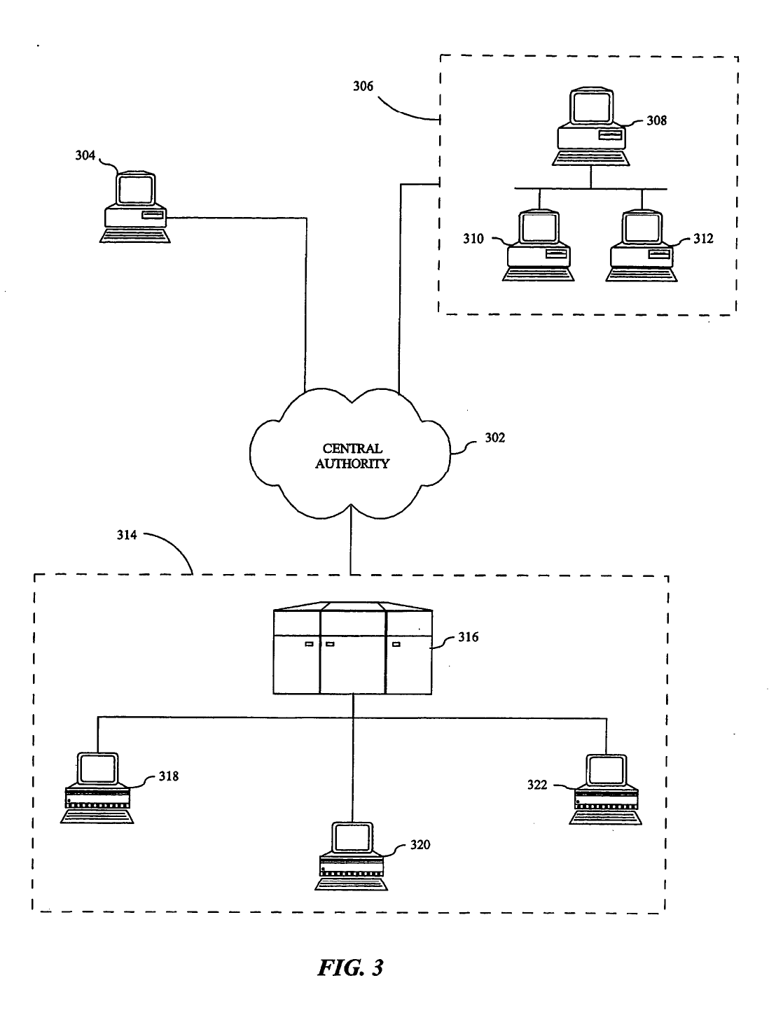

Referring now to FIG. 3, various alternative implementation schemes of the present invention are shown. In a first exemplary system, a central authority 302 is coupled with a personal computer 304. The coupling may occur through a variety of communication mediums, such as an Internet connection and the like. In this preferred embodiment, a user of the present invention may contact the central authority, initially by telephone, before establishing the link between the user's personal computer and the central authority. Alternatively, the user of the personal computer may contact the central authority through use of the personal computer. The user of the personal computer may identify to the central authority the nature of the problem (i.e, system failure, application failure, and the like), and the central authority may then establish a link with the personal computer. Once the link is established, the personal computer, using the present invention, sends a file marker encoded with the build of material information to the central authority. The file marker identifies to the central authority the source of the problem and relevant information concerning the source, such as device driver version, BIOS version, operating system version, software application version, and the like. Alternatively, the present invention may include the personal computer sending a plurality of file markers encoded with build of material information and stored in a physical storage location, to the central authority when the link is established.

A second exemplary system may comprise the central authority 302 being coupled with a networked computing environment 306. The networked computing environment 306 is shown as a system including a first computer 308, a second computer 310, and a third computer 312. It is understood that the number and configuration of the computers may vary as contemplated by one of ordinary skill in the art. Contact with the central authority 302 may occur through a manner similar to those described above. Sending of the file markers encoded with build of material information may be accomplished over the network. In this example, each computer encodes its own file markers with its own build of material information. The network is used to communicate this information to the central authority 302. In a third exemplary system, the central authority 302 is coupled with a mainframe computer 316, the mainframe computer 316 acting as an administrator for a networked computing environment 314. A first computer 318, a second computer 320, and a third computer 322 are communicatively coupled with the mainframe computer 316. As such, sending of file markers is done via the mainframe computer 316 when an application abnormally terminates. The mainframe computer 316, and not the individual computers networked to it may encode file markers with build of material information relevant and applicable to all computers networked through it. Other networked environments, distributed computing environments, and the like, as contemplated by one of ordinary skill in the art may employ the present invention without departing from the scope and spirit of the present invention.

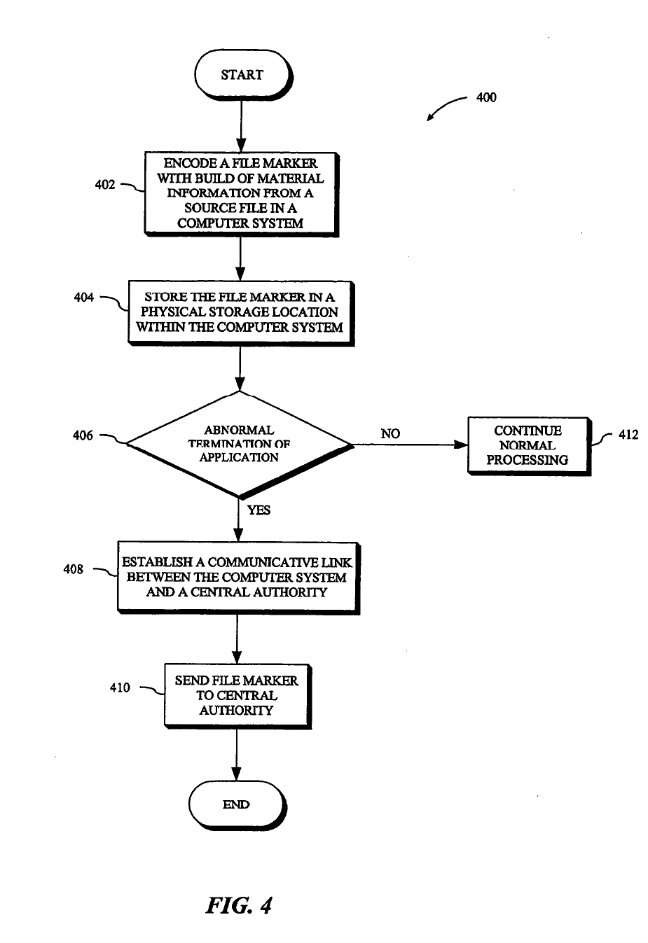

Referring now to FIG. 4, a method 400 provides a file marker to a central authority upon determination that an abnormal termination of an application has occurred in a computer system enabled with the present invention. The exemplary method begins in step 402 by providing for the encoding of a file marker with BOM information from a source file in the computer system. The file marker is then stored in a physical storage location in step 404. A determination is made as to whether or not there has been an abnormal termination of an application within the computer system in step 406. If it is determined in step 406 that there has been no abnormal termination of an application, then in step 412 the computer system continues normal processing. If it is determined in step 406 that there has been an abnormal termination of an application, then in step 408 a communicative link between the computer system and a central authority (such as those shown and described in FIG. 3) is established. Once the communicative link has been established a file marker encoded with the BOM information of the source file is sent to the central authority.

Referring now to FIG. 5, an exemplary hardware system 500 generally representative of an information handling system, such as a computer, sold or leased to host customers in accordance with the present invention is shown. For example, the computer may be a desktop personal computer (PC), a notebook PC, and the like. The hardware system 500 is controlled by a central processing system 502 (CPU). The central processing system 502 includes a central processing unit such as a microprocessor or microcontroller for executing programs, performing data manipulations and controlling the tasks of the hardware system 500. Communication with the central processor 502, by hardware components described later, is implemented through a high speed host bus 504. It is contemplated that the bus 504 may include a data channel for facilitating information transfer between storage and other peripheral components of the hardware system. The bus 504 may further provide the set of signals required for communication with the central processing system 502 including a data bus, address bus, and control bus.

In the preferred embodiment, the high speed host bus 504 connects with these hardware components through its pins, such as a PCI bus 512, an ISA bus 522, and an auxiliary bus 542. These buses provide for the transferring of information among the components of the hardware system 500.

In the current embodiment, a Host Bus-PCI Bus (HPCI) bridge circuit 508 enables communication between the host bus 504 and the PCI bus 512. In the current embodiment, the HPCI 508 includes a main memory controller and a cache controller. The main memory controller allows the HPCI 508 to control an operation for accessing main memory 510. This is accomplished by enabling the main memory controller with logic for mapping addresses to and from the CPU 502 to particular areas of the main memory 510. It is known that data transfer speeds differ between buses. Thus, the HPCI 508 further acts as a buffer to absorb any data transfer speed differences between the host bus 504 and the PCI bus 512.

The main memory 510 is a volatile random access memory (RAM) composed of a plurality of memory modules, typically DRAM (Dynamic RAM) chips. Other semi-conductor-based memory types which may be employed with the hardware system 500 may include, for example, synchronous dynamic random access memory (SDRAM), Rambus dynamic random access memory (RDRAM), ferroelectric random access memory (FRAM), and so on. The main memory 510 provides storage of instructions and data for programs executing on the central processing system 502. The programs to be executed by the CPU 502 include device drivers that access an operating system (OS), or the like and peripheral devices, application programs for specified jobs, and firmware stored in a ROM 526 (described later). The memory capacity of the RAM may vary greatly, for example, ranging from 12 MB, to 64 MB, to 256 MB, to 512 MB. It is understood that the specific configuration of the main memory 510 may vary as contemplated by one of ordinary skill in the art.

A cache memory 506 is connected to the host bus 504 and the HPCI bridge 508. Cache memory is high-speed memory for temporary storage of limited amounts of code and data that the CPU 502 frequently accesses. The cache 506 operates to absorb the time required by the CPU 502 to access the main memory. In a preferred embodiment, the cache 506 may be implemented as an L-2 cache consisting of SRAM (Static RAM) chips, or the like with memory capacity as contemplated by one of ordinary skill in the art. 100291 The buses 504, 512, 522, and 542, may comprise any state of the art bus architecture according to promulgated standards, for example, industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on.

In the preferred embodiment, the PCI bus 512 provides a relatively fast data transfer rate and directly communicates with devices such as the video controller 550. The video controller 550 couples with the video memory 554 and a video display 552. Graphic commands or the like are received from the CPU 502 by the video controller 550. The commands are processed and then temporarily stored in the video memory 554 before being output as graphics upon the video display 552. Common to video controllers is a digital to analog converter which converts a video signal to an analog signal. The analog signal may be output through CRT ports or other communication assemblies, such as LAN docking connectors, and the like. Video memory 554 may be, for example, video random access memory (VRAM), synchronous graphics random access memory (SGRAM), windows random access memory (WRAM), and the like. The video display 552 may comprise a cathode ray-tube (CRT) type display such as a monitor or television, or may comprise an alternative type of display technology such as a projection-type CRT display, a liquid-crystal display (LCD) overhead projector display, an LCD display, a light-emitting diode (LED) display, a gas or plasma display, an electroluminescent display, a vacuum fluorescent display, a cathodoluminescent (field emission) display, a plasma-addressed liquid crystal (PALC) display, a high gain emissive display (HGED), and so forth.

Other devices such as card bus controllers and the like are also typically in direct communicative contact with the PCI bus. PCI card slots are commonly found on many computers being formed in the wall or face of the computer. PC cards which conform to certain industry standards, such as those determined by the PCMCIA or JEIDA, may be used within these slots. Card bus controllers directly transmit PCI bus signals to the interface connector of a PCI card slot.

In situations where the PCI bus 512 is being tasked to interconnect with a secondary PCI bus, downstream of the PCI bus 512, a bridge circuit may be provided. In the current embodiment that bridge circuit may be identified as PCI-PCI bridge 556. An example of when this functionality may be needed is when the system 500 is a notebook computer. The notebook computer may use connector 566 to dock with and communicate with an expansion station. The expansion station may include a PCI bus as part of its hardware arrangement and connection between it and the PCI bus 512 may be enabled through the PCI-PCI Bridge 556. When a secondary PCI bus is not connected downstream, the bridge 556 may be disabled by disabling the PCI bus 512 signals at the end of the PCI bus 512. The connector 566 may be enabled as a communication subsystem and while shown coupled with the PCI bus 512 it may also couple with the ISA bus 522 for allowing the system 500 to communicate with a remote information handling system.

The present embodiment shows that the PCI bus 512 is coupled with the ISA bus 522 via a PCI Bus-ISA Bus Bridge (PCISA) 514. The PCISA 514 includes a USB route controller for connecting a USB port 516. USB devices, such as a digital camera, MP-1, tablet, mouse, and the like, may be inserted and removed from the USB port 516 while the system 500 is operating, and the hardware system 500 may provide a plug-and-play capability for reconfiguring the system configuration once a USB device has been identified. The USB router controller may further enable the operation of a peripheral USB and a general purpose bus. The PCISA 514 additionally includes an IDE (Integrated Drive Electronics) interface. This interface connects external storage devices that conform to the IDE specifications. In this manner data transfer between an IDE device 518 and the main memory 510 may occur without passing through the CPU 502. IDE device 518 may include DVD drives, HDD (hard disk drives), and the like. An IDE CD-ROM 520 is also connected with the IDE interface, preferably using an ATAPI (AT Attachment Packet Interface). The IDE device 518 and IDE CD-ROM 520 are typically located in a “media bay” of the computer. This “media bay” is usually situated for interaction by a user with its various components, which makes using the various devices easier. Other devices, which will be discussed later, may also be included within the “media bay”.

The PCI bus 512 and the ISA bus 522 are connected by the PCISA Bridge 514 allowing communication between those devices coupled with the ISA bus 522 and the CPU 502, when needed. The PCISA Bridge 514 includes power management circuitry which is coupled via AUX II with a power adapter 562 that brings power in from a power supply to the system 500. The power management circuitry allows the hardware system 500 to change between various power states, such as normal operating state, off, suspend, and the like. Enough power is supplied to the hardware system 500 so that when it is in the off or suspend state, the hardware system 500 can monitor for events which cause the system 500 to be re-enabled. In the present embodiment the power management circuitry is also enabled as a controller for the auxiliary bus 542 coupled through an ISA bus-AUX bus bridge 540 to the ISA bus 522. The ISA bus-AUX bus bridge 540 is a low speed bus, and it is contemplated that the auxiliary bus 542 may be enabled as a system management (SM) bus for enabling the functioning of a LAN adapter 564 (both the SM bus and LAN adapter will be discussed later). The power management circuitry may be further enabled as a programmable interval timer (PIT) which is configurable by a user to expire after a predetermined period of time. For example, when the timer expires, the hardware system 500 will change from the off state to the normal operating state. It is further contemplated that the PCISA Bridge 514 may include a DMA controller and a programmable interrupt controller (PIC). The DMA controller may be used for performing a data transfer between a peripheral device and the main memory 510 that the data does not pass through the CPU 502. The PIC may execute a program (an interrupt handler) in response to an interrupt request from a peripheral device to which it is coupled.

The ISA bus 522 connects with an auxiliary memory 524, ROM 526, auxiliary processors 528, a CMOS/RTC 538 (CMOS=Complementary Metal Oxide Semiconductor), an I/O controller 530, the ISA bus-AUX bus bridge 540, a keyboard/mouse controller 544, and an analog switch 558. Typically, the ISA bus 522 transfers data at a lower speed than the PCI bus 512. The auxiliary memory 524 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). The auxiliary memory 524 may also include a variety of non-semiconductor-based memories, including but not limited to magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), etc. Other varieties of memory devices are contemplated as well. The auxiliary memory 524 may provide a variety of functionalities to the hardware system 500, such as the storage of instructions and data that are loaded into the main memory 510 before execution. In this way, the auxiliary memory 524 acts in a very similar manner to the ROM 526, described below.

The ROM 526 is a non-volatile memory for the permanent storage of a code group, such as a BIOS (Basic Input/Output System) or the like having input and output signals for hardware components, such as a floppy disk drive (FDD) 532, a keyboard 546, and a mouse 548. Additionally the ROM provides for the permanent storage of firmware, such as a test program like a POST (Power on Self Test) or the like that is run when the hardware system 500 is first powered on. It is understood that the hardware system 500 may include both the auxiliary memory 524 and the ROM 526 or be enabled with only one of these memory devices without departing from the scope and spirit of the present invention.

The hardware system 500 includes an auxiliary processing system 528 which may be an auxiliary processor to manage input/output, an auxiliary processor to perform floating point mathematical operations, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor. It will be recognized that the system 500 may employ such auxiliary processors as discrete processors, processors built in to the main processor, or may not include such processors at all.

The CMOS/RTC 538 is a chip which includes an RTC (real time clock) which is used for time of day calculations and the CMOS memory. The CMOS memory is typically used to store information, such as BIOS setup values, passwords, and vital parts of a system configuration. [00391 The I/O controller 530 provides interface functionality between the one or more I/O devices 532-536 and the ISA bus 522. I/O devices include FDD 532, Parallel Port 532, and a Serial Port 536, in the present embodiment. It is contemplated that the I/O controller 512 may interface with the universal serial bus (USB) port 516, an IEEE 1394 serial bus port, infrared port, network adapter, printer adapter, radio-frequency (RF) communications adapter, universal asynchronous receiver-transmitter (UART) port, and the like. Further, it is contemplated that the I/O controller 530 may provide for the interfacing between corresponding I/O devices such as the keyboard 546, the mouse 548, trackball, touchpad, joystick, trackstick, infrared transducers, printer, modem, RF modem, bar code reader, charge-coupled device (CCD) reader, scanner, compact disc (CD) drive, compact disc read-only memory (CD-ROM) drive 520, digital versatile disc (DVD) drive, video capture device, TV tuner card, touch screen, stylus, electroacoustic transducer, microphone, speaker, audio amplifier, and the like. The I/O controller 530 and I/O devices 532-536 may provide or receive analog or digital signals for communication between the hardware system 500 of the present invention and external devices, networks, or information sources. The I/O controller 530 and I/O devices 532-536 preferably implement industry promulgated architecture standards, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It should be appreciated that modification or reconfiguration of the hardware system 500 of FIG. 5 by one having ordinary skill in the art would not depart from the scope or the spirit of the present invention.

In the preferred embodiment, the keyboard/mouse controller 544 is enabled for fetching input provided through use of the keyboard 546 and/or the mouse 548. In an alternative embodiment, it is contemplated that the functionality performed by the keyboard/mouse controller 544 may reside in the I/O controller 530. Other controllers, such as an audio signal controller for processing the input/output of audio signals may be included within the hardware system 500. An analog switch 558 couples the ISA bus 522 with the connector 566. The analog switch 558, responding to whether or not a secondary PCI bus is connected with the hardware system 500, weakens the signal at the end of the ISA bus 522 and disconnects the ISA bus 522 from the connector 566.

A power adapter 562 for transforming an external AC power source into a DC voltage is coupled with a DC/DC converter 560. The DC/DC converter 560 provides a stable DC voltage to the components of the hardware system 500. It is contemplated that power may be received via the connector 566 by the DC/DC converter 560 and then reduced and stabilized for use by the hardware system 500. In this case, the power is carried along a power feed line 572 to the DC/DC converter 560. The PCISA Bridge 514 is supplied with auxiliary power via a power feed line 570 from the DC/DC converter 560. A LAN adapter 564 (described later) receives auxiliary power via a power feed line 568 from the DC/DC converter 560. This auxiliary power source may be required when the system 500 is enabled in an “off” state. For example, when the hardware system 500 is “off” the PCISA Bridge 114 may need to monitor the hardware system 100 for events which may cause the hardware system 500 to be re-enabled. In the LAN adapter 564, auxiliary power may be required for scanning all inputs received from the LAN. The LAN adapter 564 may scan for a particular data frame coupled with the input from the LAN and, if the data frame is not found refuse the input. If the data frame is found, the LAN adapter 564 may alert (i.e., WOL) the PCISA Bridge 514, including the power management circuitry, to power the hardware system 500 to a normal operating state.

While the hardware system 500 will be referenced during description of the present invention, it is understood that the configuration of the hardware system 500 may be varied, as contemplated by one of ordinary skill in the art, without departing from the scope and spirit of the present invention. For example, the type of CPU/Processor used may vary and the type and number of controllers, busses, and devices connected to the CPU/Processor may also vary.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A method for providing build of material information in a computer system, comprising:
identifying build of material information in a source file of the computer system;
encoding a file marker with the build of material information from the source file; and
storing the file marker in a physical storage location.

2. The method of claim 1, further comprising the step of sending the file marker to a central authority when an application abnormally terminates.

3. The method of claim 1, wherein the file marker comprises a null file with a file name.

4. The method of claim 3, wherein the build of material information is encoded in the file name of the file marker.

5. The method of claim 3, wherein the file name is populated with information from a SMBIOS table.

6. The method of claim 3, wherein the file name ranges from 1 to 256 characters.

7. The method of claim 1, wherein the file marker is provided within a physical storage medium.

8. The method of claim 7, wherein the physical storage medium comprises a disk drive.

9. The method of claim 1, wherein the build of material information is selected from the group consisting of device drivers, software applications, operating systems, or BIOS versions.

10. The method of claim 1, wherein the central authority is selected from the group consisting of a server, a managing computer, a network administrator, a technical assistance center, or an automated calling center.

11. A method for providing build of material information in a computer system, comprising:
receiving a source file into the computer system;
identifying build of material information in the source file;
encoding a file marker with the build of material information from the source file; and
storing the file marker in a physical storage location.

12. The method of claim 11, wherein the receiving of the file is by a download from a computer readable medium.

13. The method of claim 11, further comprising the step of sending the file marker to a central authority when an application abnormally terminates.

14. The method of claim 11, wherein the file marker comprises a null file with a file name.

15. The method of claim 14, wherein the build of material information is encoded in the file name of the file marker.

16. The method of claim 14, wherein the file name is populated with information from a SMBIOS table.

17. The method of claim 14, wherein the file name ranges from 1 to 256 characters.

18. The method of claim 11, wherein the file marker is provided within a physical storage medium.

19. The method of claim 18, wherein the physical storage medium comprises a disk drive.

20. The method of claim 11, wherein the build of material information is selected from the group consisting of device drivers, software applications, operating systems, or BIOS versions.

21. The method of claim 11, wherein the central authority is selected from the group consisting of a server, a managing computer, a network administrator, a technical assistance center, or an automated calling center.

22. A method of providing build of material information during a software failure, comprising:
encoding a file marker with build of material information from a source file; and
sending the file marker to a central authority when an application abnormally terminates.

23. The method of claim 22, further comprising the step of storing the file marker in a physical storage location.

24. The method of claim 22, wherein the file marker comprises a null file with a file name.

25. The method of claim 24, wherein the build of material information is encoded in the file name of the file marker.

26. The method of claim 24, wherein the file name is populated with information from a SMBIOS table.

27. The method of claim 24, wherein the file name ranges from 1 to 256 characters.

28. The method of claim 22, wherein the file marker is provided within a physical storage medium.

29. The method of claim 28, wherein the physical storage medium comprises a disk drive.

30. The method of claim 22, wherein the build of material information is selected from the group consisting of device drivers, software applications, operating systems, or BIOS versions.

31. The method of claim 22, wherein the central authority is selected from the group consisting of a server, a managing computer, a network administrator, a technical assistance center, or an automated calling center.

32. A signal tangibly embodying a computer readable medium for providing build of material information, comprising:
a first command for identifying build of material information in a source file;
a second command for encoding a file marker with the build of material information from the source file; and
a third command for storing the file marker in a physical storage location.

33. The signal of claim 32, further comprising a fourth command for sending the file marker to a central authority during a software application failure.

34. The signal of claim 32, wherein the build of material information is read from a SMBIOS interface.

35. The signal of claim 32, wherein the file marker comprises a null file with a file name.

36. The signal of claim 35, wherein the build of material information is encoded in the file name of the file marker.

37. The signal of claim 35, wherein the file name is populated with information from a SMBIOS table.

38. The signal of claim 35, wherein the file name ranges from 1 to 256 characters.

39. The signal of claim 32, wherein the file marker is stored within a physical storage medium.

40. The signal of claim 39, wherein the physical storage medium is a disk drive.

41. The signal of claim 32, wherein the build of material information is selected from the group consisting of device drivers, software applications, operating systems, or BIOS versions.

42. The signal of claim 32, wherein the central authority is selected from the group consisting of a server, a managing computer, a network administrator, a technical assistance center, or an automated calling center.

43. A computer system for providing build of material information during a software failure, comprising:
a processor;
a memory coupled with the processor;
a signal, executable by the processor, wherein the signal further comprises, a means for generating a file marker and encoding the file marker with build of material information from a source file;
a communication assembly coupled with the processor, the communication assembly for sending the file marker to a central authority when an application abnormally terminates,
wherein the central authority may use the file markers in failure analysis, system restoration, and for future use in identifying and diagnosing technical support issues.

44. The computer system of claim 43, wherein the build of material information is read from a SMBIOS interface.

45. The computer system of claim 43, wherein the file marker comprises a null file with a file name.

46. The computer system of claim 45, wherein the build of material information is encoded in the file name of the file marker.

47. The computer system of claim 45, wherein the file name is populated with information from a SMBIOS table.

48. The computer system of claim 45, wherein the file name ranges from 1 to 256 characters.

49. The computer system of claim 43, wherein the file marker is provided within a physical storage medium.

50. The computer system of claim 49, wherein the physical storage medium is a disk drive.

51. The computer system of claim 43, wherein the build of material information is selected from the group consisting of device drivers, software applications, operating systems, or BIOS versions.

52. The computer system of claim 43, wherein the central authority is selected from the group consisting of a server, a managing computer, a network administrator, a technical assistance center, or an automated calling center.

53. A means for providing build of material information during a software failure, comprising:
means for encoding a file marker with build of material information from a source file; and
means for sending the file marker when an application abnormally terminates.

54. The means of claim 53, wherein the file marker comprises a null file with a file name, the file name being encoded with the build of material information.

55. The means of claim 53, wherein the file marker is sent to a central authority when an application abnormally terminates.
